(19) United States
(12) Patent Application Publication
(10) Pub. No.: US 2009/0095607 A1
(43) Pub. Date: Apr. 16, 2009

(54) SWITCH

(76) Inventors: Naoki TATEHATA, Kyoto (JP); Yousuke Chikahisa, Hyogo (JP); Tsutomu Alsaka, Osaka (JP)

Correspondence Address: MCDERMOTT WILL & EMERY LLP, 600 13TH STREET, NW, WASHINGTON, DC, 20005-3096, US

(21) Appl. No.: 12/248,526

(22) Filed: Oct. 9, 2008

(30) Foreign Application Priority Data
Oct. 15, 2007 (JP) 2007-267600

(51) Int. Cl. H01H 9/00

(52) U.S. Cl. 200/314

(57) ABSTRACT

A switch of the present invention has a light guide part having optical transparency formed between a light emitting device, which is arranged at an end of a light guide sheet, and a lower surface of the end of the light guide sheet, so that the light from the light emitting device passes through the light guide part and sufficient light can be introduced into the inside of the light guide sheet from the lower surface of the end, whereby a switch capable of realizing bright and satisfactory illumination is obtained with a simple configuration.

### BACKGROUND OF THE INVENTION

1. Field of the Invention

The present invention relates to a switch used in the operation of various electronic apparatuses.

2. Description of Related Art

Recently, in various electronic apparatuses, in particular, in a mobile terminal apparatus such as a mobile telephone, apparatuses in which a light emitting diode, an EL element, or the like emits light to illuminate an operation unit, are increasing so that identification or operation of buttons, display sheet, and the like can be easily performed even in a dark environment. Thus, switches to be used in such apparatus capable of illuminating with various lights at low cost even in a dark environment are also being desired.

One example of such conventional switch will be described with reference to FIG. 2.

A dimension in a thickness direction is shown in an enlarged manner in the figure to facilitate the understanding of the configuration.

FIG. 2 shows a cross-sectional view of a conventional switch. In FIG. 2, film-shaped cover sheet 2 having flexibility is arranged along a lower surface of film-shaped light guide sheet 1 having optical transparency and flexibility. Plural dot-shaped diffusion parts 1a are formed on an upper surface of light guide sheet 1, where light guide sheet 1 and cover sheet 2 are joined by an adhesive (not shown) at predetermined places of the outer periphery.

Movable contact point 3 is a movable contact point of substantially dome-shape made of a conductive metal thin plate. Plural movable contact points 3 are joined to a lower surface of cover sheet 2 under diffusion parts 1a by an adhesive (not shown) thereby configuring movable contact point body 4.

In wiring substrate 5 having plural wiring patterns (not shown) formed on upper and lower surfaces thereof, plural fixing contact points 6 including substantially circular middle fixing contact point 6a and substantially horseshoe-shaped or substantially ring-shaped outer fixing contacting point 6b surrounding middle fixing contact point 6a are arranged on formed on the upper surface thereof.

Movable contact point body 4 is mounted on the upper surface of wiring substrate 5, and the outer periphery of respective movable contact point 3 is mounted on outer fixing contact point 6b, so that middle 3a of a lower surface of movable contact point 3 is joined so as to face middle fixing contact point 6a with a predetermined spacing.

Light emitting device 7 such as light emitting diode is mounted on the upper surface of wiring substrate 5 on the right side of light guide sheet 1, and is arranged with light emitting surface 7a facing right side surface 1b of light guide sheet 1.

Furthermore, operation body 8 is made of insulating resin, and includes light transparent part 8a and light shield part 8b for covering an upper surface and side surfaces of light transparent part 8a. Display parts 8c where light transparent part 8a is exposed to the shapes of character, signs, and the like are formed on upper surfaces of plural operation bodies 8. In plural operation bodies 8, pressing part 8d projecting downward contacts upper surface 1c of light guide sheet 1 at the central part of movable contact point 3.

Furthermore, movable contact point body 4 and wiring substrate 5 are accommodated on the inner side of substantially box-shaped case 9 made of insulating resin. Plural operation bodies 8 are mounted to be movable in a vertical direction through plural opening holes 9a at an upper surface of case 9, thereby configuring the switch.

The switch configured as above is mounted on an operation plane of the electronic apparatus, and middle fixing contact point 6a, outer fixing contact point 6b, light emitting device 7, and the like are electrically connected to an electronic circuit (not shown) of the apparatus by way of a wiring pattern.

In the configuration of the switch above, predetermined operation body 8 is pressed downward to cause the electronic apparatus to perform the desired operation. Pressing part 8d at a lower surface of the relevant place then presses upper surface 1c of light guide sheet 1, whereby light guide sheet 1 and cover sheet 2 bend and the substantially dome-shaped central part of movable contact point 3 is pressed. If a predetermined pressing force is applied in such manner, movable contact point 3 elastically inverts downward with a click feeling, and middle 3a of the lower surface of movable contact point 3 contacts middle fixing contact point 6a. Middle fixing contact point 6a and outer fixing contact point 6b are then electrically connected by way of movable contact point 3.

When the pressing force on operation body 8 is released, movable contact point 3 elastically inverts upward by the elastic recovery force. Middle 3a of the lower surface of movable contact point 3 then moves away from middle fixing contact point 6a, whereby middle fixing contact point 6a and outer fixing contact point 6b are electrically disconnected.

Each function of the apparatus is switched according to the electrical contact and separation of fixing contact point 6. When power is supplied to light emitting device 7 from the electronic circuit of the apparatus therewith, light emitting device 7 emits light. Then, the light enters the inside of light guide sheet 1 from right side surface 1b, and transmits to the left while being reflected in the inside of light guide sheet 1.

The light is diffused and reflected by plural diffusion parts 1a of upper surface 1c of light guide sheet 1, and illuminates light transparent part 8a of operation body 8 from the lower side. Display part 8c is thereby illuminated from lower side, so that display of characters, signs, and the like of display part 8c can be identified and the operation can be easily performed even in a dark environment.

In other words, upper surface 1c of light guide sheet 1 is pressed by the pressing operation of operation body 8, whereby movable contact point 3 is elastically inverted to perform electrical contact and separation of fixing contact point 6. The light of light emitting device 7 is introduced into the inside of light guide sheet 1 from right side surface 1b to light diffusion part 1a. As a result, display part 8c of operation body 8 is illuminated by light emitting device 7.

Unexamined Japanese Laid-Open Patent Publication No. 2007-87749 and the like are known as related art document information related to the invention of this application.

However, in the conventional switch, since the light of light emitting device 7 is introduced into the inside of light guide sheet 1 from right side surface 1b perpendicular to the light, sufficient light cannot be introduced into the inside of light guide sheet 1 if a sheet having a thin thickness is used for light guide sheet 1, and light illumination of plural diffusion parts 1a becomes dark.

### SUMMARY OF THE INVENTION

In view of solving the problems of the related art, the present invention provides a switch capable of satisfactorily illuminating with a simple configuration.

The switch of the present invention is a switch in which a light guide part having optical transparency is formed between a light emitting device, which is arranged at an end of a light guide sheet, and a lower surface of the end of the light guide sheet.

According to such configuration, the light from the light emitting device passes through the light guide part and sufficient light can be introduced into the inside of the light guide sheet from the lower surface of the end of the light guide sheet. A switch capable of realizing bright and satisfactory illumination is thereby obtained with a simple configuration.

According to the present invention, an advantageous effect of realizing a switch capable of performing satisfactory illumination with a simple configuration is obtained.

### BRIEF DESCRIPTION OF DRAWINGS

FIG. 1 shows a cross-sectional view of a switch according to one embodiment of the present invention; and

FIG. 2 shows a cross-sectional view of a conventional switch.

### DETAILED DESCRIPTION OF THE PREFERRED EMBODIMENT

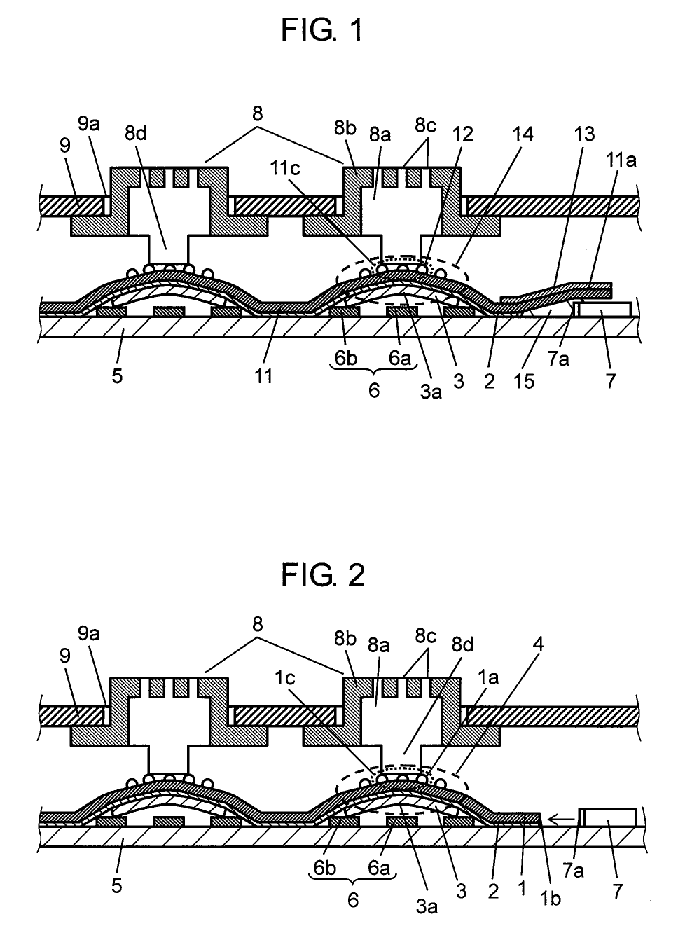

An embodiment of the present invention will be described with reference to FIG. 1.

A dimension in a thickness direction is shown in an enlarged manner in the figure to facilitate the understanding of the configuration.

Same reference numerals are denoted for portions of the same configuration as the configuration described in the section of Background Art, and detailed description will be simplified.

### Embodiment

FIG. 1 shows a cross-sectional view of a switch according to one embodiment of the present invention. In FIG. 1, light guide sheet 11 having optical transparency is a light guide sheet of film-shape having flexibility. Light guide sheet 11 is made of material such as polyethylene terephthalate and polycarbonate, polyurethane, silicone and the like. Plural dot-shaped diffusion parts 12 are formed on an upper surface of light guide sheet 11 by material such as acrylic resin dispersed with white pigment such as titanium oxide.

Aluminum foil, aluminum deposition film, and the like are joined to the upper surface of right end 11a of light guide sheet 11, or transparent resin such as polyester or epoxy dispersed with scale-like aluminum, silver, or the like is printed on the upper surface of right end 11a of light guide sheet 11, thereby forming reflecting part 13.

An adhesive (not shown) is applied to predetermined places of the outer periphery on an upper surface of film-shaped cover sheet 2, and cover sheet 2 is joined to a lower surface of light guide sheet 11 by such adhesive.

Movable contact point 3 is a movable contact point of a substantially dome-shape made of conductive metal thin plate such as copper alloy and steel. Plural movable contact points 3 are joined to a lower surface of cover sheet 2 under diffusion parts 12 by an adhesive (not shown), thereby configuring movable contact point body 14.

Furthermore, wiring substrate 5 is a wiring substrate of film-shape made of polyethylene terephthalate and polycarbonate, or of plate-shape made of paper phenol and epoxy with glass having plural wiring patterns (not shown) formed on upper and lower surfaces of thereof by copper and the like. According therewith, plural fixing contact points 6 including substantially circular middle fixing contact point 6a and substantially horseshoe-shaped or substantially ring-shaped outer fixing contacting point 6b surrounding middle fixing contact point 6a are arranged on the upper surface of wiring substrate 5 by copper, carbon, or the like.

Movable contact point body 14 is mounted on the upper surface of wiring substrate 5, and the outer periphery of respective movable contact point 3 is mounted on outer fixing contact point 6b. Furthermore, middle 3a of a lower surface of movable contact point 3 is then joined so as to face middle fixing contact point 6a with a predetermined spacing.

Light emitting device 7 such as light emitting diode is mounted on the upper surface of wiring substrate 5 on the right side of light guide sheet 11. Right end 11a of light guide sheet 11 is mounted on light emitting device 7 while being bent slightly upward. Light guide part 15 having optical transparency made of insulating resin such as acrylic, polymethyl methacrylate, polyurethane, silicone, and the like is formed between light emitting device 7 and a lower surface of right end 11a of light guide sheet 11.

Furthermore, operation body 8 is formed by insulating resin such as polystyrene and ABS, and includes light transparent part 8a and light shield part 8b for covering an upper surface and side surfaces of light transparent part 8a. Display parts 8c where light transparent part 8a is exposed to the shapes of character, signs, and the like are formed on upper surfaces of plural operation bodies 8. In plural operation bodies 8, pressing part 8d projecting downward contacts upper surface 11c of light guide sheet 11 at the central part of movable contact point 3.

Furthermore, movable contact point body 14 and wiring substrate 5 are accommodated on the inner side of substantially box-shaped case 9 made of insulating resin. Plural operation bodies 8 are mounted to be movable in a vertical direction through plural opening holes 9a at an upper surface of case 9, thereby configuring the switch.

In order to form such switch, light emitting device 7 is mounted by soldering on the upper surface of wiring substrate 5 formed with plural fixing contact points 6. Thereafter, it is tilted towards the left side in a substantially triangular shape from a light emitting surface on the left side of light emitting device 7, and the insulating resin is applied or printed on the upper surface of wiring substrate 5, and then dried thereby forming light guide part 15 having optical transparency.

Thereafter, movable contact point body 14 mounted with plural movable contact points 3 at the lower surface and joined on plural fixing contact points 6 thereof has right end 11a of light guide sheet 11 bent slightly upward, and placed on light emitting device 7. Light guide sheet 11 is joined to the upper surface of wiring substrate 5 so as to cover light guide part 15.

Furthermore, wiring substrate 5 joined with movable contact point body 14 is assembled in case 9 mounted with plural operation bodies 8 so that pressing part 8d contacts upper surface 11c of light guide sheet 11 at central part of movable contact point 3, thereby completing the switch.

Light guide part 15 may be formed not only on the upper surface of wiring substrate 5 but on right end 11a of light guide sheet 11, and may be contacted to the light emitting surface of light emitting device 7 in assembly. However, light guide part 15 can be more easily formed by forming light guide part 15 tilted to the left side of light emitting device 7, and joining light guide sheet 11 so as to cover the same.

The switch configured as above is mounted on an operation surface of the electronic apparatus, and middle fixing contact point 6a, outer fixing contact point 6b, and light emitting device 7 are connected to the electronic circuit (not shown) of the apparatus by way of a wiring pattern.

In the configuration of the switch described above, predetermined operation body 8 is pressed downward to cause the electronic apparatus to perform the desired operation. Pressing part 8d at the lower surface of the relevant place then presses upper surface 11c of light guide sheet 11, whereby light guide sheet 11 and cover sheet 2 bend and the substantially dome-shaped central part of movable contact point 3 is pressed. Thus, when predetermined pressing force is applied in such manner, movable contact point 3 elastically inverts downward with a click feeling, and middle 3a of the lower surface of movable contact point 3 contacts middle fixing contact point 6a. Middle fixing contact point 6a and outer fixing contact point 6b are then electrically connected by way of movable contact point 3.

When the pressing force on operation body 8 is released, movable contact point 3 elastically inverts upward by the elastic recovery force. Middle 3a of the lower surface of movable contact point 3 then moves away from middle fixing contact point 6a, whereby middle fixing contact point 6a and outer fixing contact point 6b are electrically disconnected.

Each function of the apparatus is switched according to the electrical contact and separation of fixing contact point 6. When power is supplied to light emitting device 7 from the electronic circuit of the apparatus therewith, light emitting device 7 emits light. Then, the light passes through light guide part 15, and enters the inside of light guide sheet 11 from the lower surface of right end 11a to which light guide part 15 is contacted.

Furthermore, the light entered to the inside of light guide sheet 11 straightly transmits through the inside of light guide sheet 11 or transmits towards the left while being reflected by upper and lower surfaces of light guide sheet 11, and then is diffused and reflected by plural diffusion parts 12 on the upper side of movable contact point 3. The light emitted from light emitting device 7 thus illuminates transparent part 8a of operation body 8 from the lower side and illuminates display part 8c. Therefore, display of characters, signs, and the like of display part 8c can be identified and the operation can be easily performed even in a dark environment.

In other words, upper surface 11c of light guide sheet 11 is pressed by the pressing operation of operation body 8, whereby movable contact point 3 is elastically inverted to perform electrical contact and separation of fixing contact point 6. The light of light emitting device 7 is introduced into the inside of light guide sheet 11 from the lower surface of right end 11a to which light guide part 15 is contacted, thereby light emitting diffusion part 12. The light of light emitting device 7 thus illuminates display part 8c of operation body 8.

In this case, the light of light emitting device 7 passes through light guide part 15 having optical transparency arranged between light emitting surface 7a of light emitting device 7 and the lower surface of right end 11a of light guide sheet 11. Great amount of light is then introduced into the inside of light guide sheet 11 from a wide area of the lower surface of right end 11a of light guide sheet 11 to which light guide part 15 is contacted, and the light illuminates transparent part 8a, whereby bright and easily viewable illumination is performed.

In other words, light guide part 15 having optical transparency is arranged between the light emitting surface of light emitting device 7 and the lower surface of right end 11a of light guide sheet 11 even if light guide sheet 11 of thin thickness is used. As the light of light emitting device 7 is introduced from a wide area of the lower surface of right end 11a to which light guide part 15 is contacted, sufficient light necessary for illumination can be introduced to the inside of light guide sheet 11.

Light leakage to the upper side of light guide sheet 11 can be prevented by arranging reflecting part 13 of aluminum, silver, or the like on the upper surface of right end 11a of light guide sheet 11 formed with light guide part 15. At the same time, the light to the upper side of the inside of light guide sheet 11 can be reflected by reflecting part 13, so that brighter illumination can be realized.

The material of light guide part 15 is preferably materials of the same system as the material of light guide sheet 11 and having substantially the same refractive index of light. For instance, if polyethylene terephthalate or polycarbonate is used for light guide sheet 11, acryl or polymethyl methacrylate is used for the material of light guide part 15. If polyurethane or silicone is used for light guide sheet 11, the same material, polyurethane or silicone, is preferably used for the material of light guide part 15, and material having a refractive index of greater than or equal to 1.4 or smaller than or equal to around 1.6 is preferably used.

If ultraviolet (UV) curable acryl or polymethyl methacrylate is used for the material of light guide sheet 11, drying is unnecessary after application or printing when forming light guide part 15. Therefore, the working time for forming light guide part 15 is reduced, and light guide part 15 can be easily formed.

Furthermore, in the above-described description, a configuration in which cover sheet 2 joined with plural movable contact points 3 at the lower surface thereof is joined to the lower surface of light guide sheet 11 is described. The number of configuring parts can be reduced, and a simpler and more inexpensive switch can be achieved by adopting a configuration in which cover sheet 2 is not joined and plural movable contact points 3 are directly joined to the lower surface of light guide sheet 11.

According to the present embodiment, the light of light emitting device 7 passes through light guide part 15, and sufficient light can be introduced into the inside of light guide sheet 11 from a lower surface of the end by forming light guide part 15 having optical transparency between light emitting device 7 arranged at the end of light guide sheet 11 and the lower surface of the end of light guide sheet 11. Thus, a switch enabling bright and satisfactory illumination can be obtained with a simple configuration.

According to the present embodiment a switch having reflecting part 13 arranged on the upper surface of the end of light guide sheet 11 is configured, where brighter illumination can be performed by reflecting the light to the upper side with reflecting part 13.

In the description above, a configuration in which plural dot-shaped diffusion parts 12 are formed on the upper surface of light guide sheet 11 above movable contact point 3 has been described, but the present invention can also be implemented with a configuration of arranging diffusion parts 12 not on the upper surface but on the lower surface of light guide sheet 11.

The switch according to the present invention has an advantageous effect of being able to provide satisfactory illumination with a simple configuration, and is useful for the operation of various electronic apparatuses.

What is claimed is:

1. A switch comprising:
a light guide sheet having optical transparency,
a movable contact point of a substantially dome-shape formed by a conductive metal thin plate mounted on a lower surface of the light guide sheet;
a wiring substrate having a fixed contact point, which faces the movable contact point, on its upper surface; and
a light emitting device arranged at an end of the light guide sheet; wherein
a light guide part having optical transparency is formed between the light emitting device and a lower surface of the end of the light guide sheet.

2. The switch according to claim 1, wherein a reflecting part is arranged on an upper surface of the end of the light guide sheet.
